(19) United States
(12) Patent Application Publication
(10) Pub. No.: US 2010/0319631 A1
(43) Pub. Date: Dec. 23, 2010

(54) Animal Training Device

(75) Inventor: Peter C. Rane, Southbury, CT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: WALKADOG, INC., Provo, UT (US)

(21) Appl. No.: 12/756,478

(22) Filed: Apr. 8, 2010

Related U.S. Application Data
(60) Provisional application No. 61/219,063, filed on Jun. 22, 2009.

(51) Int. Cl. A01K 15/00; A01K 27/00

(52) U.S. Cl. 119/792; 119/799

(57) ABSTRACT

The present invention is an animal training device with a rigid crossbar and a flaccid attachment to a trained animal. The attachment is ideally a leash, but may also be a halter or harness. The rigid crossbar is configured for two-handed operation and the preferred embodiment is curved to accommodate use across a person's body and bent to provide greater leverage for controlling the animal. The particular disclosed embodiment positions the animal along the side of the user and provides grips to indicate hand position and increase frictional hold on the crossbar.

### CROSS-REFERENCES TO RELATED APPLICATIONS

This Application claims priority as a non-provisional perfection of prior filed U.S. Provisional Application 61/219,063, filed Jun. 22, 2009, and incorporates the same by reference herein in its entirety.

### FIELD OF THE INVENTION

The present invention relates to the field of animal training devices and more particularly relates to a training leash or halter with a rigid bar configured for two-handed operation.

### BACKGROUND OF THE INVENTION

Part of good animal husbandry is the training of an animal to obey and behave in a manner the owner of the animal finds appropriate. This is particularly true with dogs, which are common pets and companions to humans. Some are even specially trained for tasks that help various professions, such as law enforcement, so that these dogs may even be termed partners with their human handlers. Because of the almost universal acknowledgement of dogs and their training, this application will use dogs as an exemplar for other trainable animals. These other trainable animals would include cattle and livestock, other pets, and trained animals for performances. The use of the term “dog” should not be seen as limiting the invention's use to the canine species alone.

When training a dog, or other trainable animal, it is important to emphasize the behaviors an owner wants to repeat while discourage undesirable behaviors. Two important behaviors most owners desire their dogs to exhibit are to obey their voice and to walk next to the owner instead of wandering wherever the dog may desire. This makes the act of walking the dog more pleasurable for the owner and also lessens any trouble the dog may otherwise cause. Most leashes for dogs are a flaccid strip of leather, cord or other material that the owner attaches to the dog's collar and then the owner holds the other end of the leash. This gives much freedom to the dog to wander about the owner. Many leashes on the market attempt to provide more control to the owner by making the leash adjustable or retractable into some form of spool, thus lessening the range a dog may wander. Some in the prior art even use a length of rod to increase control of the dog. However, this type of leash is usually operated by a single hand. Holding a leash with one hand may be sufficient to control smaller dogs, but often larger dogs can jerk the leash and either move the owner where the dog wishes to go or, even worse, jerk the leash out of the owner's hand and run free. Both scenarios are so well known that they are often depicted in movies and other art forms as a comical plot device.

Another dog restraint that has been used in the past is a rigid dog restraint. Much like the leash, it fastens on the dog's color or about its neck and is held by a human, usually an animal control officer. The usual construction is some form of rod with a flaccid leash attached thereto or tube through which a cable passes and forms a loop on one end that it tightened about the dog's neck. These are usually used in situations where control of the dog is a premium, such as by animal control officers. These devices are used to keep the dog's head away from the user and to, almost violently in some cases, force the dog to move in a particular direction. While they are adequate to control the dog, these devices are not suitable for training most dogs as they do not foster the relationship the owner usually desires with the dog because of the dominating nature of the device.

Neither of these devices is suitable to address the primary needs in dog training, which is to keep the dog from wandering and to adequately restrain the dog, in a friendly manner, to encourage obedience. The present invention is a departure from the prior art in that it provides the control of the rigid rod while simultaneously allowing a friendlier relationship with the dog, or whatever animal is being trained.

### SUMMARY OF THE INVENTION

In view of the foregoing disadvantages inherent in the known types of animal training devices, this invention provides an improved, rigid handled animal leash. As such, the present invention's general purpose is to provide a new and improved training device that is easily operated by two hands and maintains the animal in a desired position, preferably next to the animal's owner.

To accomplish these objectives, the animal training device comprises a rigid crossbar with an attachable flaccid leash extension. The crossbar ideally may be bent in a manner to increase leverage an owner may exert upon the crossbar to control the animal and also to position the animal at the owner's side.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top plan view of one embodiment of the invention.

FIG. 2 is a perspective view of the embodiment depicted in FIG. 1, with the flaccid leash removed.

FIG. 3 is a top perspective view depicting the embodiment of FIG. 1 in use.

FIG. 4 is a front perspective view of the depiction in FIG. 3.

FIG. 5 is a front perspective view of the embodiment of FIG. 1 being used to control a dog.

FIG. 6 is a front perspective view of the embodiment depicted in FIG. 2 with an alternate animal attachment.

FIG. 7 is a front perspective view of the embodiment depicted in FIG. 2 with a further alternate animal attachment.

### DETAILED DESCRIPTION OF THE PREFERRED EMBODIMENT

With reference now to the drawings, a preferred embodiment of the animal training device is herein described. It should be noted that the articles “a”, “an”, and “the”, as used in this specification, include plural referents unless the content clearly dictates otherwise.

The following reference numerals are used throughout the figures:

1 the animal training device, generally;

10 crossbar;

12 main body of crossbar;

14 bend in crossbar;

16a first grip;

16b second grip;

18a attachment point;

18b orifice;

20 flaccid leash;

22 swivel hook;

24 animal collar;

26 animal harness;

28 animal halter;

30 individual user;

32 animal (dog);

34 animal (goat).

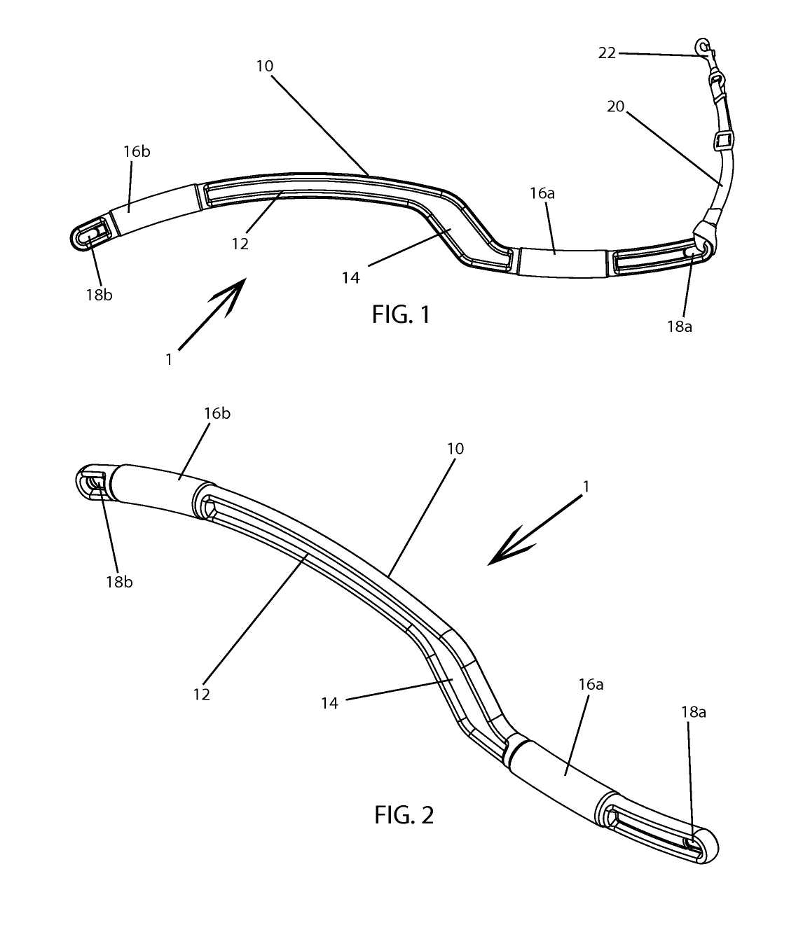

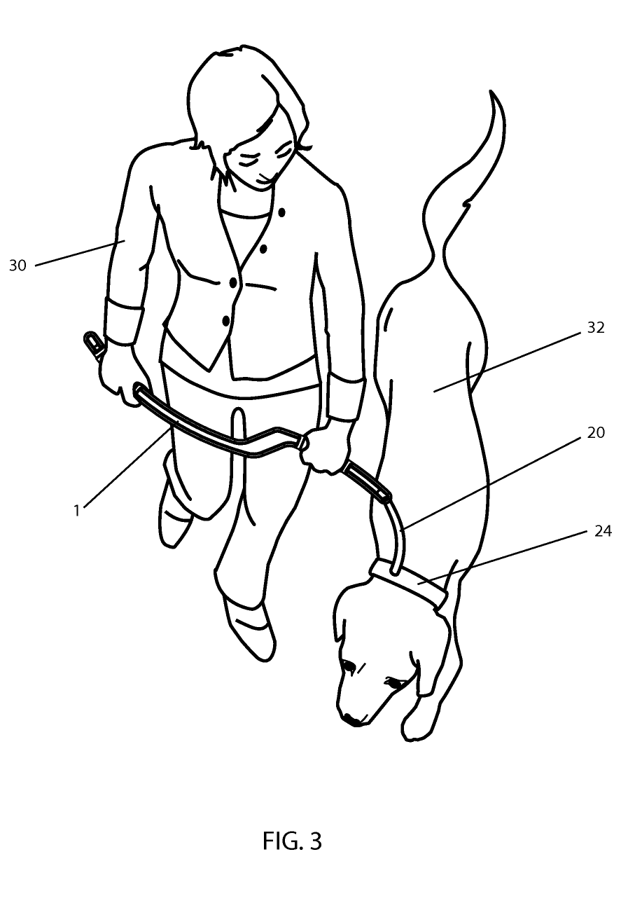

With reference to FIGS. 1 and 2, a preferred embodiment of the invention is depicted. In general form, the device 1 comprises a crossbar 10 with an attachment point 18a for a flaccid leash 20. The device 1 is configured for two-handed operation, and should have two grips 16a, 16b, upon which a user may grasp. A preferred embodiment of the device 1 divides the crossbar 10 into sections, a main body 12, a bend 14, and an attachment end comprising one grip 16a and the attachment point 18a. In this preferred embodiment, the main body 12 is manufactured with a curve and the bend 14 is a distinct increase and then reversal of that curve. A second hand grip 16b is positioned on the main body 12.

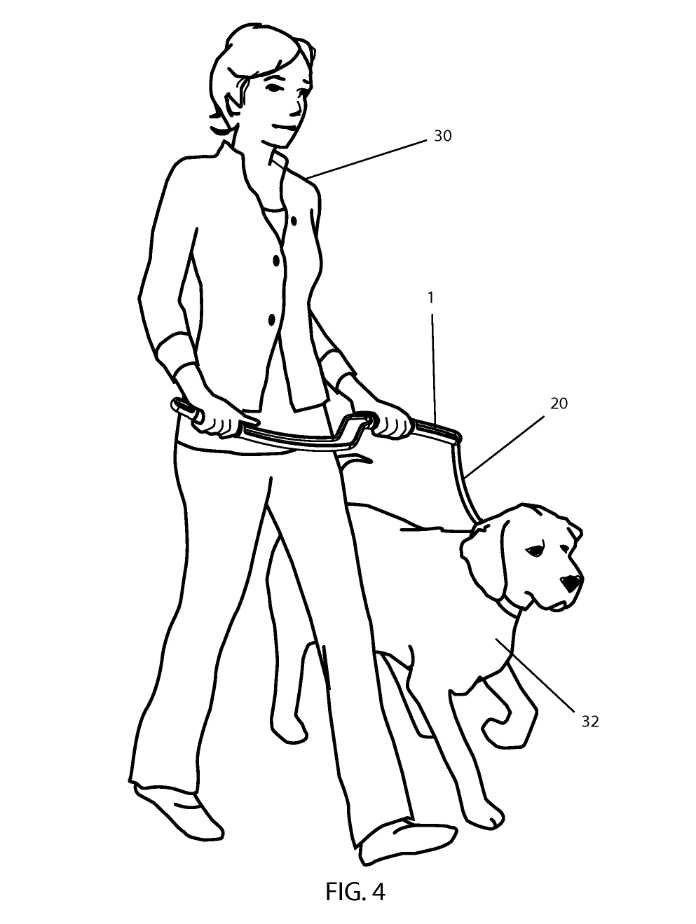

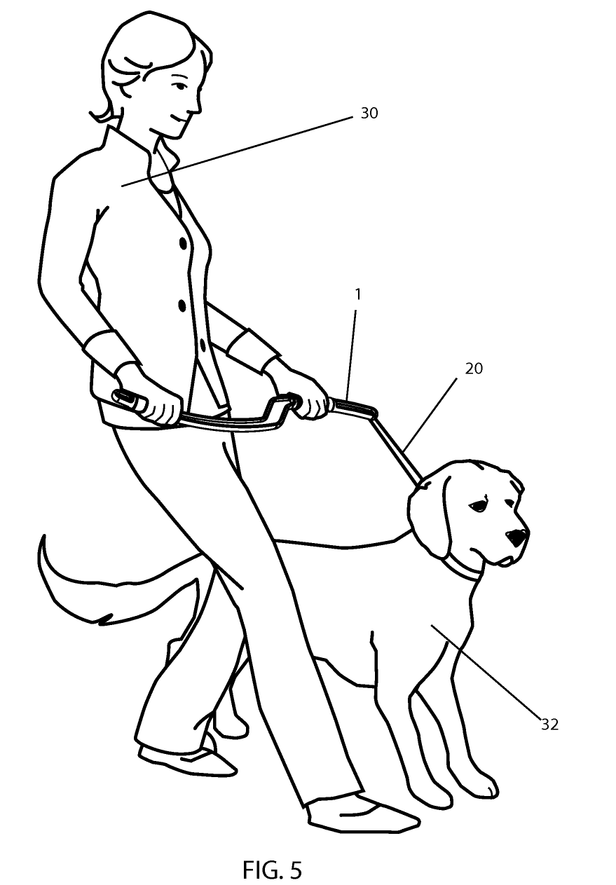

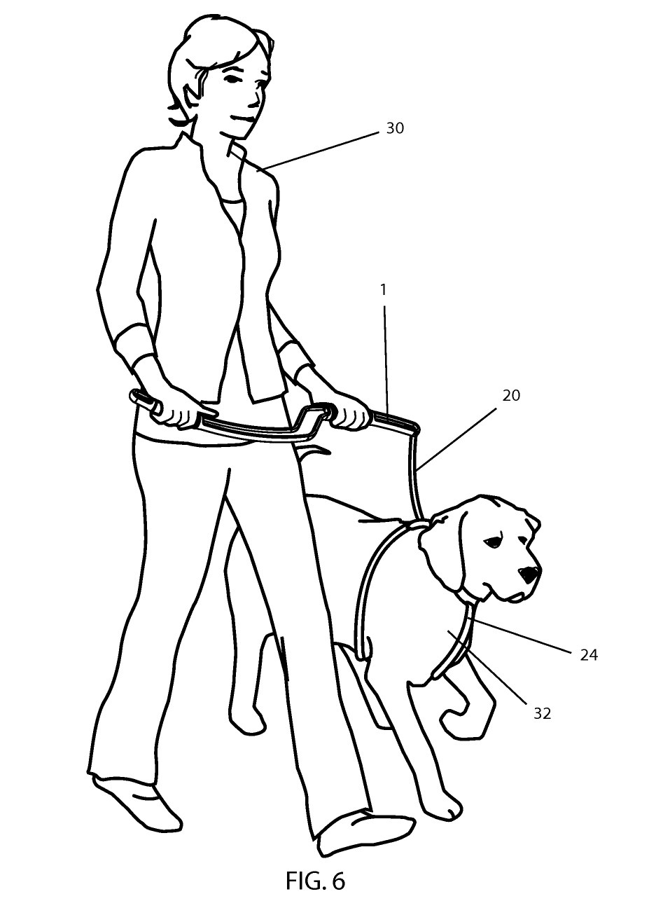

The configuration of the main body 12 and bend 14 is such that a user may comfortably hold the crossbar 10 across his or her body, as depicted in FIGS. 3 and 4, the curve of the main body 12 providing some accommodation for the user's body when in use. It also increases the leverage a user may apply with the non-dominant hand. The bend 14 hooks the first, dominant, grip 16a and attachment point 18a behind the non-dominant grip 16b and around the user's body such that the animal 32 is positioned more directly by the side of the user 30. This positioning of an animal when walking is preferred by most trainers and experts. It also turns the entire crossbar 10 into a lever to magnify the force applied to the animal to aid in restraining the animal 32. Should the need arise, as shown in FIG. 5, the user 30 may apply counter force to the animal 32 in an effort to maintain control. Using both hands not only provides a more secure grip, but the leverage afforded the non-dominant hand magnifies the force it may apply to the animal 32, thus providing greater ability to control the animal 32.

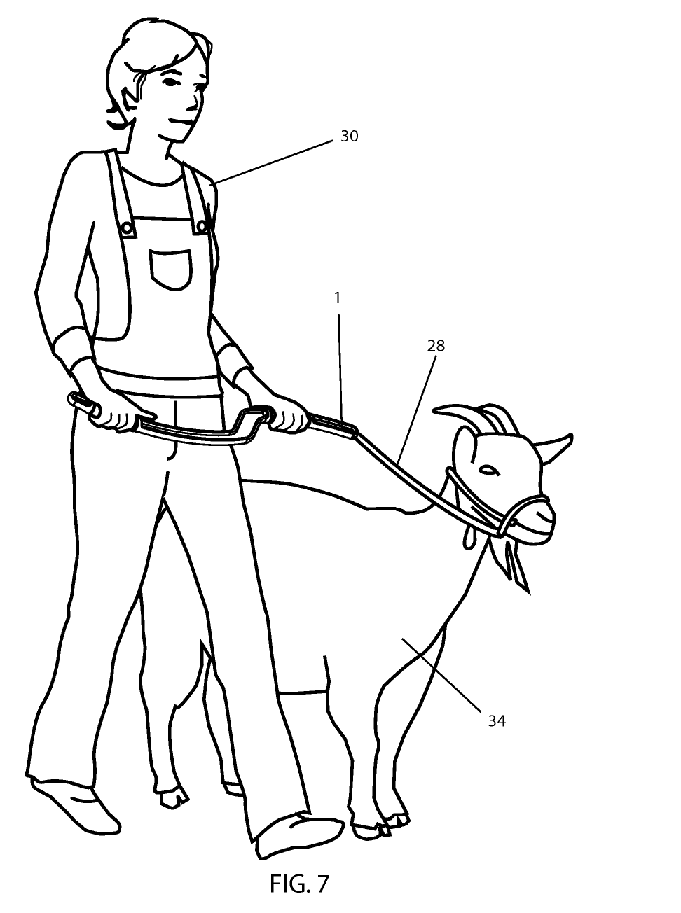

In construction, the crossbar 10 may be fashioned of any sufficiently rigid material, such as plastic, metal, wood or composite material. The grips 16a, 16b may be integral with the crossbar 10 and fashioned from the same material, or they may be separately formed of any suitable material, including wood, metal, rubber, plastic, and foam, and added to the crossbar 10. The grips 16a, 16b serve as indicators for hand position and also may be textured in conventional manner to provide a surface with increased friction to aid in maintaining a grip on the device. The flaccid leash 20 may be manufactured from any suitable material, including cloth, webbing, chain links, leather, or rope. At one end, the leash should thread through or in some way be fastened to the attachment point 18a and then terminate at the other end in some means to attach to the animal, such as swivel 22 which would attach to the animal's collar 24. Other forms of attachment are possible as the leash 20 could attach to a full harness 26 (FIG. 6) or halter, or even be a full harness or halter 28 (FIG. 7), depending upon the standards acceptable for the type of animal and the desires of the user. One other optional feature is the addition of an orifice 18b at the end opposite the attachment point 18b, which may be used for a second attachment point or as a hanging point for storage on a wall hook or other structure.

Although the present invention has been described with reference to preferred embodiments, numerous modifications and variations can be made and still the result will come within the scope of the invention. The device may be used on any type of animal, the training of which would include walking with the owner/trainer. This would include dogs, cattle, sheep, goats, some pigs, large cats and any other animal capable of being walked. The shape of the crossbar 10 is depicted in the figures as a preferred embodiment; however, other shapes, such as absolutely straight or another combination of bends, will also work in this invention. The invention is capable of use in both a right-handed and a left-handed manner. No limitation with respect to the specific embodiments disclosed herein is intended or should be inferred.

What is claimed is:

1. An animal training device comprising:
a. A rigid crossbar having two ends;
b. An animal attachment means connected to the rigid crossbar at one end; and
c. Two hand grips positioned on a surface of the rigid crossbar between the ends.

2. The animal training device of claim 1, the crossbar further comprising a bend positioned between the two grips such that one end is considered behind the other.

3. The animal training device of claim 2, the crossbar being curved between the bend and forward grip.

4. The animal training device of claim 1, the animal attachment means being selected from the set of animal attachment means consisting of a flaccid leash, a halter and a harness.

5. The animal training device of claim 4, the crossbar further comprising a bend positioned between the two grips such that one end is considered behind the other.

6. The animal training device of claim 5, the crossbar being curved between the bend and forward grip.
